(19) United States
(12) Patent Application Publication
(10) Pub. No.: US 2005/0082411 A1
(43) Pub. Date: Apr. 21, 2005

(54) Belt retractor for a vehicle safety belt

(75) Inventors: Martin Prokscha, Schwaebisch Gmuend (DE); Wolfgang Holbein, Alfdorf (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 10/964,068

(22) Filed: Oct. 13, 2004

(30) Foreign Application Priority Data
Oct. 15, 2003 (DE) 103 47 992.9

(51) Int. Cl. B60R 22/34

(52) U.S. Cl. 242/390.8; 280/807

(57) ABSTRACT

A belt retractor for a vehicle safety belt has a frame (40), a belt spool drive part (12) which is rotatably arranged on the frame and can be connected with a belt spool. The belt spool drive part is provided with outer teeth (16) and with a catch (26) which can be guided into the outer teeth by means of a slip coupling (22). The slip coupling has a friction spring (52).

The invention relates to a belt retractor for a vehicle safety belt.

### BACKGROUND OF THE INVENTION

DE 201 15 316 shows a belt retractor with a frame, a belt spool drive part which is rotatably arranged on the frame and can be connected with a belt spool, the belt spool drive part being provided with outer teeth, and with a catch which can be guided into the outer teeth by means of a slip coupling. The belt retractor shown in this publication has an electromotor by means of which a precautionary belt band tensioning can take place in a critical situation, e.g. with a full braking. Through the pretensioning, any existing belt slack can already be removed before an accident, in order to minimize the risk of injury for occupants. In addition, the mode of operation of a belt tensioner can be improved compared with a conventional system. In the known belt retractor, a slip coupling is provided, by means of which the catch can be guided into the outer teeth in order to rotate the belt spool. The slip coupling is formed by elastic tongues on a coupling disc, and a stop element. Reference is made expressly to the disclosure of this publication with regard to achieving the pretensioning.

The object of the invention consists in further developing a belt retractor of the type initially mentioned to the effect that a more compact and more favourably priced construction is produced and a quicker response is achieved of the coupling between electromotor and belt spool.

### DETAILED DESCRIPTION OF THE INVENTION

For this purpose, in accordance with the invention provision is made that the slip coupling has a friction spring. This leads to a compact construction, because the friction spring can be integrated in a very space-saving manner into other functional parts of the belt retractor. In addition, this results in lower production costs. Finally, the slip coupling does not have any play, so that an immediate response results, without a dead path.

According to a preferred embodiment, provision is made that the friction spring is a ring spring which is inserted into a groove on the coupling disc. This embodiment is distinguished in that no additional structural space is required for the friction spring.

Advantageous developments of the invention will be apparent from the sub-claims.

### BRIEF DESCRIPTION OF THE DRAWINGS

Further features and advantages of the invention will be apparent from the following description of a preferred embodiment and from the enclosed drawings, to which reference is made. In the drawings:

FIG. 1 shows a diagrammatic exploded drawing of the belt retractor;

FIG. 2 shows a section through the components of FIG. 1 in the installed state;

FIG. 3 shows a side view of the coupling formed with the catch in an initial position; and

FIG. 4 shows a side view of the coupling formed with the catch, the catch being guided in.

### DETAILED DESCRIPTION OF THE INVENTION

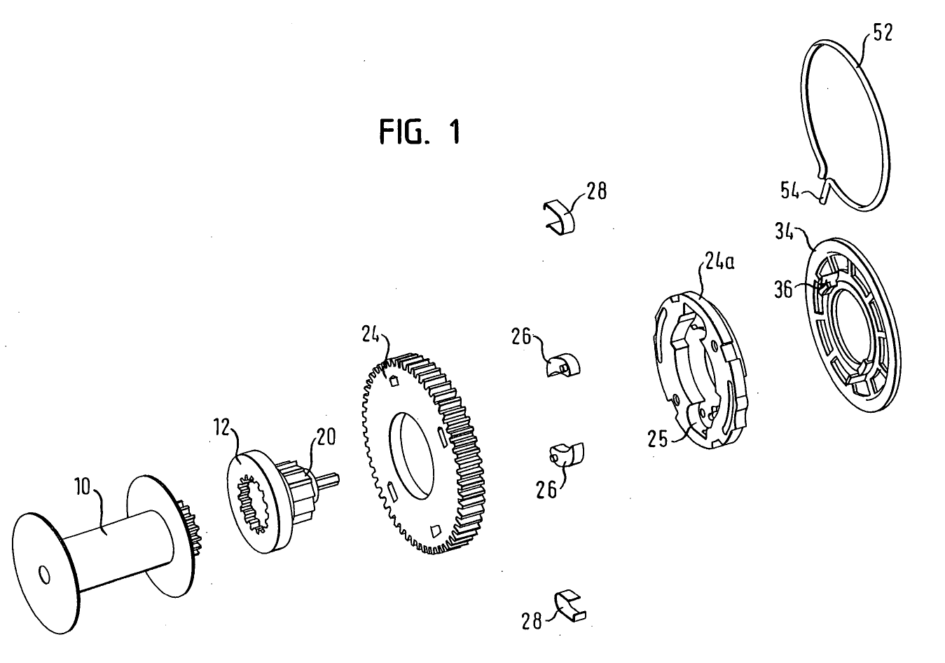

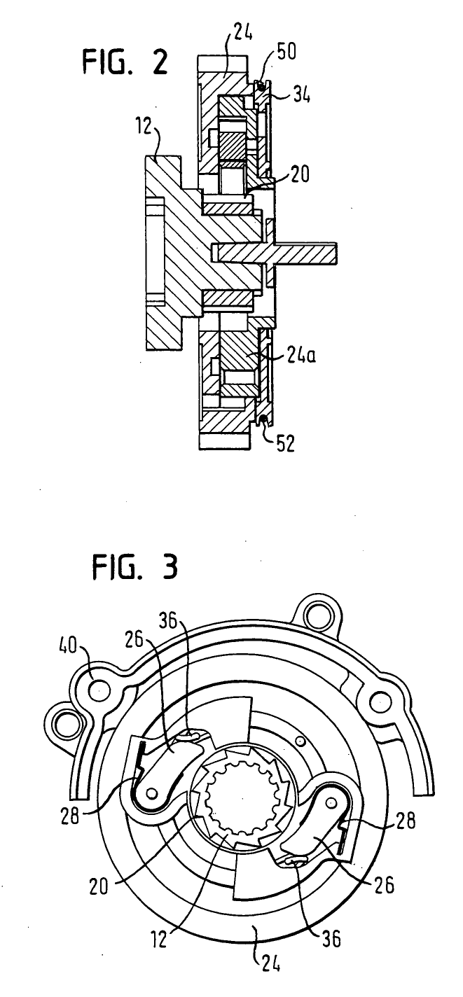

The exploded drawing in FIG. 1 shows a belt retractor for a vehicle safety belt with a belt spool 10 and belt spool drive part 12, which is coupled with the belt spool 10 so as to be secure with regard to rotation and has outer teeth 20. The outer teeth are part of a coupling by means of which a drive moment can be transferred from a wheel 24 to the belt spool. The wheel 24 is connected with an electromotor (not illustrated) (see the DE 210 15 316).

The wheel 24 has an insert part 24a, in which several pockets 25 are constructed, in which respectively a catch 26 is arranged, on which a restoring spring 28 acts. Each catch is arranged together with its restoring spring in one of the pockets 25, and the insert part 24a is arranged, for example arrested, on the wheel. The catches are then held swivellably in the respective pocket.

Axially adjacent to the wheel 24 a coupling disc 34 is arranged, which is provided with control tongues 36 which project through recesses in the insert part 24a into the wheel 24, so that they can cooperate with the catches. On their side facing away from the wheel 24, the coupling disc 34 has a groove 50, in which a friction spring 52 is arranged. The internal diameter of the friction spring 52 in the initial state is smaller than the external diameter of the groove 50, so that the friction spring sits with a certain prestressing in the groove 50. The friction spring 52 is a ring spring, which has at one end a bent arm 54 which is held stationary on the frame 40 of the belt retractor so as to be secure with regard to rotation. In this way, the friction spring 52 together with the coupling disc 34 forms a slip coupling, because it makes possible a slipping through of the coupling disc 34 as soon as the holding moment between friction spring and groove is overcome.

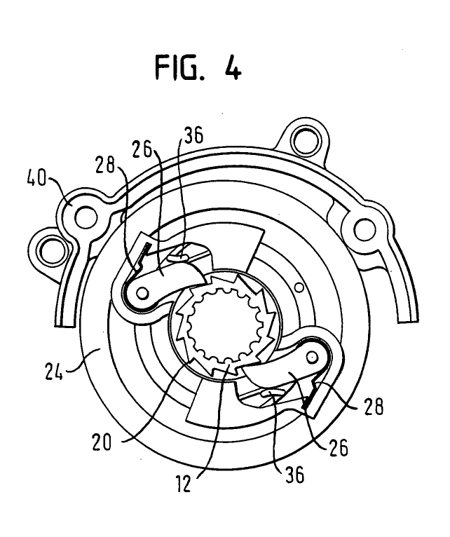

The mode of operation of the belt retractor is to be illustrated below with the aid of FIGS. 3 and 4.

In the initial position (FIG. 3), the catches 26 are held back by the restoring springs 28 so that they are not in engagement with the outer teeth 20 of the belt spool drive part 12. In this case, the belt spool 10 can rotate freely (FIG. 3) and belt band can be withdrawn from the belt spool.

If the wheel 24 is set in rotation by the electromotor (not illustrated), the catches are entrained. As the coupling disc 34 is secured by means of the friction spring 52, the catches 26 run onto the control tongues 36 and are guided into the teeth 20 (FIG. 4). The wheel 24 is now coupled with the belt spool 10, and a pretensioning can be carried out. Here, the coupling disc 34 is entrained by means of the control tongues 36, which is possible without difficulty owing to the slip coupling between the coupling disc and the frame of the belt retractor.

To release the connection between the wheel 24 and the belt spool 10, the wheel 24 is turned in the opposite direction, so that the coupling disc 34 stays back with respect to the wheel and the control tongues 36 make it possible for the catches to arrive into their initial position again under the action of the restoring springs 28.

1. A belt retractor for a vehicle safety belt, with a frame (40), a belt spool drive part (12) which is rotatably arranged on said frame and can be connected with a belt spool, said belt spool drive part being provided with outer teeth (16) and with a catch (26) which can be guided by means of a slip coupling (22) into said outer teeth, said slip coupling comprising a friction spring (52).

2. The belt retractor according to claim 1, characterized in that said catch (26) is mounted in a wheel (24), that a coupling disc (34) is provided and that said slip coupling is adapted for allowing a relative rotation between said wheel (24) and said coupling disc (34).

3. The belt retractor according to claim 2, characterized in that said friction spring (52) is arranged on said coupling disc (34).

4. The belt retractor according to claim 3, characterized in that said friction spring (52) is a ring spring which is inserted into a groove (50) on said coupling disc (34).

5. The belt retractor according to claim 4, characterized in that an external diameter of said friction spring (52) in an initial state is smaller than an internal diameter of said groove (50).

6. The belt retractor according to claim 4, characterized in that said friction spring (52) has a bent arm (54) which is held stationary on said frame (40).
